(19) United States
(12) Patent Application Publication
(10) Pub. No.: US 2007/0255467 A1
(43) Pub. Date: Nov. 1, 2007

(54) Method for determining a rolling condition via frequency analysis of the rotation of the suspension stop

(76) Inventor: Olivier Blanchin, Annecy (FR)

Correspondence Address: BACHMAN & LAPOINTE, P.C., 900 CHAPEL STREET, SUITE 1201, NEW HAVEN, CT, 06510, US

(21) Appl. No.: 11/789,340

(22) Filed: Apr. 24, 2007

(30) Foreign Application Priority Data
Apr. 27, 2006 (FR) 06 03800

(51) Int. Cl. B60G 17/018; G06F 17/00

(52) U.S. Cl. 701/38; 701/37

(57) ABSTRACT

A method for determining at least one rolling condition of a motor vehicle wheel, which wheel being mounted on the chassis of the vehicle via a MacPherson strut integrating a suspension stop which includes a rotating component in relation to the chassis is described. The method envisages using a device for detecting the angular displacements of the rotating component, which device is suitable for generating an analogue signal which is representative of the angular displacements according to time. The method envisages carrying out a frequency analysis of the analogue displacement signal such as to obtain a spectrum including at least one frequency window wherein at least one datum of the spectrum is based on a rolling parameter; measuring at least one of the data; determining, from the measured datum or data, at least one rolling condition corresponding to the rolling parameter or to the development of the rolling parameter.

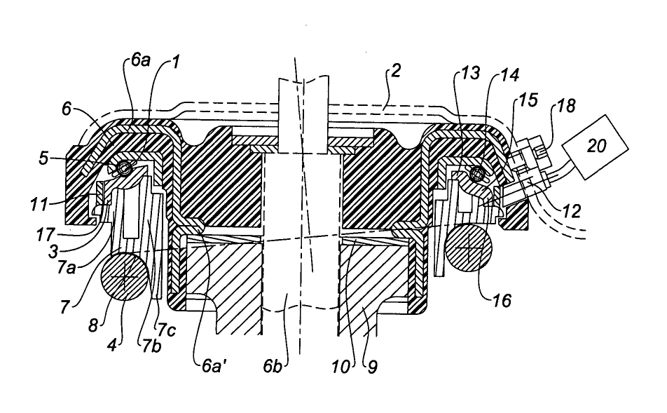

### BACKGROUND

(1) Field of the Invention

The invention relates to a method for determining at least one rolling condition of a motor vehicle wheel, as well as an assembly including a suspension stop integrated into a MacPherson strut via which a motor vehicle wheel is mounted on the chassis of said vehicle.

(2) Prior Art

In a number of applications, in particular in the control systems of the dynamics of a motor vehicle as for example ABS or ESP, it is necessary to periodically determine some of the rolling conditions of a motor vehicle wheel. In particular, the rolling conditions to be determined may include the air pressure in the tyre of the wheel.

To determine the pressure of the tyre, it is known to use a direct measurement by envisaging, for example, a pressure sensor secured to the wheel and, secured to the chassis, a device for detecting the signal generated by the sensor such as to make available the measurement in the system of coordinates of the vehicle.

Said determination strategy has the limitations inherent to the need for a specific integration of the sensor and of the detection device, as well as said of a specific mutual communication mode.

Moreover, methods for determining a wheel condition are known which in particular envisage processing of the rotation speed of the wheel. However, with such an indirect strategy for determining a rolling condition, it proves difficult to decorrelate the various rolling parameters which affect the rotation speed signal of the wheel.

### SUMMARY OF THE INVENTION

The invention aims to solve the aforementioned problems by proposing in particular an indirect method for determining a rolling condition, and this at the level of the suspension stop integrated into the MacPherson strut.

In relation thereto, and according to a first aspect, the invention proposes a method for determining at least one rolling condition of a motor vehicle wheel, said wheel being mounted on the chassis of said vehicle via a MacPherson strut integrating a suspension stop which includes a rotating component in relation to the chassis, said method envisaging to use a device for detecting the angular displacements of the rotating component, said device being suitable for generating an analogue signal which is representative of said angular displacements according to time, said methods envisaging:
carrying out a frequency analysis of the analogue displacement signal such as to obtain a spectrum including at least one frequency window wherein at least one datum of said spectrum is based on a rolling parameter;
measuring at least one of said data;
determining, from the measured datum or data, at least one rolling condition corresponding to the rolling parameter or to the development of said rolling parameter.

According to a second aspect, the invention proposes an assembly including a suspension stop integrated into a MacPherson strut via which a motor vehicle wheel is mounted on the chassis of said vehicle, said stop including a fixed component and a rotating component on which the suspension spring is resting, said assembly including a device for detecting the angular displacements of the rotating component in relation to the fixed component, said device being suitable for generating an analogue signal which is representative of said angular displacements according to time. The assembly further includes a device for determining at least one rolling condition of the wheel, said device including frequency analysis means of the analogue displacement signal, means for measuring at least one datum of said spectrum and processing means of said data which are suitable for determining at least one rolling condition of the wheel.

### BRIEF DESCRIPTION OF THE DRAWINGS

Other particularities and advantages of the invention will appear in the description which follows made referring to the attached FIGURE showing partially and in longitudinal cross-section an assembly including a suspension stop according to one embodiment of the invention.

### DETAILED DESCRIPTION OF THE PREFERRED EMBODIMENT(S)

The invention relates to a method for determining at least one rolling condition of a motor vehicle wheel on the ground. As known, the wheel is mounted on the chassis 2 of the motor vehicle via a MacPherson strut which allows suspension of the body in relation to the ground. In relation thereto, the MacPherson strut conventionally includes a shock absorber, a suspension spring as well as a suspension stop on which the spring 4 is resting.

The suspension stop includes an upper fixed component 1 and a lower rotating component 3 on which the spring 4 is resting such as to cause the rotation of said rotating ring. Indeed, when the spring 4 is under compression loading and pressure release, the rolling of the coils of said latter on themselves is modified, which results in rotation of the rotating component 3.

During said applied forces, the system has a mass-spring type dynamic behaviour, the MacPherson strut connecting the suspended mass of the vehicle to the non-suspended mass in contact with the ground. Furthermore, the tyre of the wheel also has a spring/shock absorber type dynamic operation. The dynamic behaviour of said system therefore has natural frequencies which depend on the characteristics of each of the components forming the latter, in particular the characteristics of the shock absorber, of the spring 4 and of the tyre.

The invention such as above presented aims to analyse the dynamic behaviour of the MacPherson strut in order to be able to determine at least one rolling condition of the wheel.

To do so, the method envisages using a device for detecting the angular displacements of the rotating component 3 of the suspension stop. The device is suitable for generating an analogue signal which is representative of said angular displacements according to time, said displacements depending on the dynamic behaviour of the MacPherson strut and wheel.

In relation to the FIGURE, an assembly is described including a suspension stop and such a detection device, said device including a pulse-generating encoder 11 which is secured during rotation to the rotating component 3 and a fixed sensor 12 in relation to the encoder 11 which is suitable for detecting the pulses such as to generate the analogue signal according to time. According to the embodiment shown, the sensor 12 is secured to the chassis 2 of the vehicle, but it may also be envisaged to make secure said sensor of one component of the MacPherson strut, in particular the fixed component 1 of the suspension stop.

In one particular example, the encoder 11 is made of a multipolar magnetic ring in synthetic material loaded with magnetic particles, in particular ferrite, a plurality of pairs of North and South poles being produced on said ring. However, in view of the low amplitude of the rotation, an encoder 11 including only one multipolar annular section may be envisaged.

The associated sensor 12 may include at least two sensitive elements which are for example chosen in the group including the Hall effect probes, the magnetoresistors, the giant magnetoresistors or the TMR (for Tunnel MagnetoResistance) type probes. Indeed, as known, said probes allow an analogue signal to be provided according to the rotation of the encoder 11 opposite of which they are placed at air gap distance.

In one alternative embodiment, it is also possible to use another technology for generating the signal, for example an optical technology by using an encoder having optical patterns and an optical detector placed facing said encoder.

The determination method envisages performing a frequency analysis of the analogue displacement signal, for example, by performing a temporal FFT Fourier transform of said signal. Said analysis allows the individual temporal frequencies of the displacement signal to be extracted from the rotating component 3, and to respectively allocate to them an amplitude.

As aforementioned, the dynamic behaviour of the assembly including the wheel and the MacPherson strut depends on the specific characteristics of each of the components of said assembly. Consequently, the frequency analysis may be carried out such that the spectrum obtained includes the frequency windows wherein at least one datum of the spectrum is based on a rolling characteristic corresponding with a characteristic of a component.

In particular, a calibration of the assembly including the wheel and the MacPherson strut may be carried out for establishing a relationship between at least one datum of the spectrum and the rolling condition. In an alternative embodiment, a digital simulation may be carried out in relation thereto. Moreover, it is noted that the influence of the steering angle of the wheel may be decorrelated from determination of the rolling condition because the natural frequency of the latter is not of the same order of magnitude as said produced by the rolling dynamic conditions.

According to one embodiment, the rolling parameter is chosen in the group of parameters affecting the stiffness of the assembly including the wheel and the MacPherson strut, in particular the pressure of the tyre of the wheel, the wear state of said tyre, the state of the shock absorber of the MacPherson strut. Indeed, the value of each one of said parameters affects the stiffness of the assembly and therefore the natural frequencies which are extracted by the FFT Fourier transform analysis.

In an alternative embodiment, the rolling parameter may be chosen in the group of parameters extrinsic to the assembly including the wheel and the MacPherson strut whilst affecting the dynamic behaviour of the latter, such as the state of the road on which the wheel rolls.

In particular, it is possible to distinguish a frequency window including at least one line, the function datum of the rolling parameter being chosen in the group including the amplitude of the line, the width of the line, the frequency of the line, or a combination of said characteristics.

The method according to the invention envisages measuring at least one datum in the window corresponding to the rolling condition to be determined. In an alternative embodiment, it may be envisaged to measure a plurality of data in the same window and/or to measure one or more data in more than one window, each one of said data being based on the rolling condition to be determined.

According to a first embodiment, the rolling condition is then determined by comparing the datum measured with a calibration value corresponding to the rolling parameter. In particular, the calibration value may be extracted from an evolution law of the datum according to the rolling parameter, said law being able to be established via experimentation or via simulation.

In said embodiment, the method allows a rolling condition to be determined in the form of a rolling parameter, for example the pressure of the tyre. Furthermore, the periodic implementation of the method allows the rolling parameter to be continuously monitored and therefore makes it available in real time for, for example, a control computer of the dynamics of the vehicle.

In an alternative embodiment, the rolling parameter may be recorded periodically, the calibration value being adjusted according to the history of values recorded. Said embodiment allows possible deviations to be taken into account in the time of the evolution law between the datum and the rolling parameter.

According to a second embodiment, the rolling condition is determined by comparing the variation of a rolling parameter with a threshold corresponding to said condition. In said embodiment, it is, for example, possible to determine a “flat tyre” rolling condition if the pressure in the tyre varies by more than a given percentage in a predetermined time range.

In particular, when the rolling parameter is recorded periodically, said parameter may be compared with at least one value recorded such as to determine the rolling condition.

When the method according to the invention is implemented to determine a plurality of rolling conditions, it may be envisaged that some of said conditions correspond to the rolling parameters and that others correspond to rolling parameter evolutions. In particular, for the pressure of the tyre, a joint determination of the value of said, pressure and that of a “flat tyre” condition may be envisaged, said two conditions thus being able to be treated in a differentiated way in the intervention strategy of the control systems of the dynamics of the vehicle.

Moreover, the rolling condition may be further determined by using at least one other rolling parameter. According to one embodiment, said other rolling parameter may be the angle of the steering wheel operating the wheel, the rotation speed of said wheel, the deformation of the suspension stop, the pressing down of the suspension and/or the rotation angle of the rotating component of the stop. Thus, via merging of the data, it is possible to improve the decorrelation in the spectrum between the respective influence of said parameters and of the rolling parameters to be determined.

According to one other embodiment, the additional parameter may concern another assembly including the wheel and the MacPherson strut of the vehicle. In particular, it is possible to make reliable the determination of the pressure of a tyre according to the invention by using the determination of the pressure of at least one of the other tyres, in particular the tyre of the other wheel of the same axle. Indeed, by comparing the two pressures, it is possible to distinguish if the rolling condition affects one tyre or both tyres.

According to an additional embodiment, the determination method according to the invention may allow the measurement of a rolling parameter to be made reliable. In particular, the determination method may envisage comparing a direct measurement of the pressure of a tyre with the predetermined pressure via frequency analysis, such as to take advantage of a redundancy on said determination.

The invention also relates to an assembly including a suspension stop an embodiment of which is shown in the attached FIGURE. The stop includes a upper fixed ring 1, a lower rotating ring 2 and the rolling bodies 5 placed between said rings such as to allow relative rotation of said rings around a substantially vertical axis.

In the embodiment shown, the suspension stop includes an upper cup 6 associated with the upper ring 1, said cup being associated with the chassis 2, and a lower cup 7 associated with the lower ring 3.

The lower cup 7 is made of an essentially annular part which includes a housing 8 wherein the extreme portion of the spring 4 is resting providing a relative attachment during rotation of the spring 4 on the lower cup 7. Thus, the dynamic response of the spring 4 on the lower cup 7 is transformed, due to the rolling of the coils of the spring 4, in angular displacement of the lower ring 3 in relation to the upper ring 1. The lower cup 7 is for example obtained by moulding of a polyamide type thermoplastic material 6.6.

The upper cup 6 is made of an essentially annular part which, in the embodiment shown, is made from rubber moulded from a casting on an annular stiffening insert 6a, said cup including a fitted bore 6b for receiving the end of the rod of the suspension shock absorber.

The insert 6a includes a radial annular portion and a cylindrical skirt extending axially downwards from the outer edge of the radial portion. The axial skirt includes an annular radial lap 6a′ for resting a bump stop 9 via an insert 10 mounted on said bump stop.

The bump stop 9 includes an annular portion and a cylindrical skirt extending axially downwards from the outer edge of the radial portion.

The rings 1, 3 of the rolling each consist of a stamped sheet metal washer which are respectively associated, for example by fitting, with the two cups 6, 7, said rings including raceways placed opposite such as to receive the rolling bodies 5 which, in the embodiments shown, are spherical. In particular, the geometries of the cups 6, 7 and associated rings 1, 3 are fitted to allow reliable attachment of the rings 1, 3 on the cups 6, 7, and said in particular in relation to the radial forces.

Although the description of the invention is made in relation to a “third generation” type suspension stop wherein the filtering block is integrated into the upper cup 6, the invention is directly transposable by the person skilled in the art to suspension stops having another general structure, i.e. wherein the various functional components of the stop are fitted differently. Furthermore, the description made is also directly transposable to a suspension stop of the without rolling type, for example of the smooth bearing type or including a elastomeric part that may be deformed during torsion, said stop always including a fixed component and a rotating component under the forces exerted by the spring 4.

The assembly further includes a device for detecting the angular displacements of the rotating component in relation to the fixed component, said device being suitable for generating an analogue signal which is representative of said angular displacements according to time. In the embodiment shown, the encoder is associated with the lower ring such as to allow a radial reading of the pulses originating from the encoder.

More specifically, the lower ring includes, from inside towards the outside and connected with one another, a radial crown 13, the raceway 14 and a crown including a radial portion 15 and an axial portion 16. The inner crown 13 is axially offset upwards in relation to the radial portion 15. The lower cup 7 includes the upper side of two cylindrical projections 7a, 7b intended to be housed respectively against a crown 13, 15 such as to provide reliable connection of the lower ring 3 on the cup 7. Moreover, the lower cup 7 includes, on the lower side, a cylindrical projection 7c which forms the axial wall of the housing 8, the radial wall of said housing being formed by the lower face of the body of the lower cup 7.

The encoder 11 is moulded from a casting on an annular cylindrical bearing surface of a frame 17 which is associated, for example by fitting, on the lower axial face of the axial portion 16 such that the frame 17 is resting on the outer radial face of the axial portion 16.

The sensor 12 is associated with the chassis 2 by means of a screw 18, said chassis and the upper cup 6 including a housing for receiving said sensor such as to position the sensitive elements facing and at air gap distance from the encoder 11. Furthermore, the reliability of said positioning is improved by the fact that the encoder 11 is resting on the axial portion 16, and that the sensor 12 includes a bevelled end allowing the sensitive elements to be placed in a plane substantially parallel to the plane of the encoder 11, and this without interfering with the encoder 11 during its rotation.

The invention is not only limited to one particular mode for integrating the detection device in the assembly, the person skilled in the art being able, for example, to refer to document FR-2 847 516 which describes a plurality of possible embodiments.

The assembly further includes a device for determining 20 at least one rolling condition of the wheel, such as to be able in particular to implement the method such as previously described. In the embodiment shown, the determination device 20 is connected to the sensor 12 via a cable-controlled connection, however, other modes of communication of the signals may be envisaged. Furthermore, the place for locating the determination device 20 in the vehicle may be chosen without relative constraint to the invention, including being located in the central computer of the vehicle.

According to one embodiment, the device consists of a arithmetic unit including frequency analysis means of the analogue displacement signal, means for measuring at least one datum of said spectrum and processing means of said data which are suitable for determining at least one rolling condition of the wheel. Furthermore, the determination device 20 may include means for storing data.

1. A method for determining at least one rolling condition of a motor vehicle wheel, said wheel being mounted on a chassis of said vehicle via a MacPherson strut integrating a suspension stop which includes a rotating component in relation to the chassis, said method comprising using a device for detecting the angular displacements of the rotating component; using said device to generate an analogue signal which is representative of said angular displacements according to time; carrying out a frequency analysis of the analogue displacement signal such as to obtain a spectrum including at least one frequency window wherein at least one datum of said spectrum is based on a rolling parameter; measuring at least one of said data; and determining, from the measured datum or data, at least one rolling condition corresponding to the rolling parameter or to the development of said rolling parameter.

2. A determination method according to claim 1, wherein the frequency analysis step comprises performing the frequency analysis via temporal FFT Fourier transform.

3. A determination method according to claim 1, wherein the at least one frequency window includes at least one line, and further said method further comprises choosing a function datum of the rolling parameter from a group consisting of an amplitude of the at least one line, a width of the at least one line, a frequency of the at least one line, and a combination thereof.

4. A determination method according to claim 1, further comprising choosing the rolling parameter from a group of parameters influencing the stiffness of the assembly including the wheel and the MacPherson strut.

5. A determination method according to claim 4, wherein said choosing step comprising choosing the rolling parameter from the group consisting of a tire pressure of the wheel, a wear state of the tire, and a state of a shock absorber of the MacPherson strut.

6. A determination method according to claim 1, wherein the rolling condition determining step comprises comparing the measured datum with a calibration value corresponding to the rolling parameter.

7. A determination method according to claim 5, further comprising periodically recording the rolling parameter and adjusting the calibration value according to a history of values recorded.

8. A determination method according to claim 1, wherein the rolling condition determining step comprises comparing a variation of a rolling parameter with a threshold corresponding to said condition.

9. A determination method according to claim 8, further comprising periodically recording the rolling parameter and comparing said parameter with at least one value recorded so as to determine the rolling condition.

10. A determination method according to claim 1, further comprising determining the rolling condition using at least one other rolling parameter selected fro the group consisting of a steering angle operating the wheel, a rotation speed of the wheel, a deformation of the suspension stop, a pressing down of the suspension and/or a rotation angle of the rotating component of the stop, and a pressure of at least one of the tires of the other wheels where the rolling condition determined is the pressure of the tire of the wheel.

11. An assembly including a suspension stop integrated into a MacPherson strut via which a motor vehicle wheel is mounted on a chassis of a vehicle, said stop including a fixed component and a rotating component on which a suspension spring is resting, said assembly including a device for detecting angular displacements of the rotating component in relation to the fixed component, said device generating an analog signal which is representative of said angular displacements according to time, said assembly further including a device for determining at least one rolling condition of the wheel, means for frequency analysis of the analog displacement signal, means for measuring at least one datum of a spectrum and processing means for determining at least one rolling condition of the wheel.
